(19) United States
(12) Patent Application Publication
(10) Pub. No.: US 2024/0378494 A1
(43) Pub. Date: Nov. 14, 2024

(54) SYSTEMS AND METHODS FOR EXTRACTING MEANINGFUL PHRASES AND A CRUX OF A CONVERSATION FROM TEXT DATA

(71) Applicant: Verizon Patent and Licensing Inc, Basking Ridge, NJ (US)

(72) Inventors: Subham BISWAS, Thane (IN); Durgesh KUMAR, Bangalore (IN); Ebenezer BARDHAN, Chennai (IN)

(73) Assignee: Verizon Patent and Licensing Inc., Basking Ridge, NJ (US)

(21) Appl. No.: 18/316,983

(22) Filed: May 12, 2023

(51) Int. Cl. G06N 20/00; G06F 16/36; G06F 40/166; G06F 40/205; G06F 40/253; G06F 40/35

(52) U.S. Cl. CPC G06N 20/00; G06F 16/36; G06F 40/166; G06F 40/205; G06F 40/253; G06F 40/35

(57) ABSTRACT

A device may receive taxonomy data and may preprocess the taxonomy data with preprocessing techniques to generate preprocessed data. The device may process the taxonomy data, with a machine learning interpolative-based feedback model, to generate intents, features of each of the intents, and a taxonomy collection, and may process the taxonomy data, with a machine learning-based feedback model, to generate concepts or entities associated with the intents. The device may combine the intents, the features, the taxonomy collection, and the concepts or the entities to generate an association collection, and may train a machine learning model with the association collection and the preprocessed data to generate a trained machine learning model. The device may process text data, the taxonomy collection, and the association collection, with the trained machine learning model, to determine a crux of the text data, and may perform actions based on the crux of the text data.

### BACKGROUND

A user device (e.g., a mobile telephone, a tablet computer, a desktop computer and/or the like) may utilize applications that enable the user device to conduct calls, conduct live chats, provide interactive voice responses (IVR), provide inputs to chatbots, and/or the like.

### BRIEF DESCRIPTION OF THE DRAWINGS

FIGS. 1A-1I are diagrams of an example associated with extracting meaningful phrases and a crux of a conversation from text data.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for extracting meaningful phrases and a crux of a conversation from text data.

### DETAILED DESCRIPTION OF EXAMPLE EMBODIMENTS

The following detailed description of example implementations refers to the accompanying drawings. The same reference numbers in different drawings may identify the same or similar elements.

Huge volumes of unstructured and/or structured call or chat transcript data require extraction of meaningful information and/or phrases that provide cruxes of whole conversations. The transcript data may include any type of text based or call transcript based conservations received via chatbots, live chats, calls, interactive voice responses, and/or the like. Manual identification of the meaningful information and/or phrases is impractical due to the sheer size of the transcript data. However, identification of the meaningful information and/or phrases in transcript data may provide cruxes of whole conversations; a quick understanding of customer journeys, issues, and needs; an improved search experience; identification of novel categories; and/or the like. Thus, current techniques for identifying meaningful information and/or phrases in transcript data consume computing resources (e.g., processing resources, memory resources, communication resources, and/or the like), networking resources, and/or other resources associated with failing to identify meaningful information and/or phrases in transcript data, failing to identify cruxes of conversations provided in transcript data, being unable to utilize the meaningful information and/or phrases and the cruxes of conversations, and/or the like.

Some implementations described herein provide an extraction system that extracts meaningful phrases and a crux of a conversation from text data. For example, the extraction system may receive taxonomy data associated with different domains, and may preprocess the taxonomy data with one or more preprocessing techniques to generate preprocessed data. The extraction system may process the taxonomy data, with a machine learning interpolative-based feedback model, to generate intents, features of each of the intents, and a taxonomy collection, and may process the taxonomy data, with a machine learning-based feedback model, to generate concepts or entities associated with the intents. The extraction system may combine the intents, the features, the taxonomy collection, and the concepts or the entities to generate an association collection, and may process the preprocessed data, with machine learning accelerator models, to generate accelerated data. The extraction system may generate training data based on the association collection and the accelerated data, and may train a machine learning model with the training data to generate a trained machine learning model. The extraction system may receive text data associated with a chatbot, a live chat, or an interactive voice response system, and may process the text data, the taxonomy collection, and the association collection, with the trained machine learning model, to determine a crux of the text data. The extraction system may perform one or more actions based on the crux of the text data.

In this way, the extraction system extracts meaningful phrases and a crux of a conversation from text data. For example, the extraction system may receive taxonomy data associated with different domains and may utilize a machine learning interpolative taxonomy feedback model to generate a taxonomy collection based on the taxonomy data. The extraction system may utilize a machine learning taxonomy feedback model to generate an association collection based on the taxonomy data, and may train a machine learning model with the association collection and the taxonomy data. The extraction system may receive text data associated with a chatbot, a live chat, an IVR, and/or the like, and may process the text data, the taxonomy collection, and the association collection, with the trained machine learning model, to determine a crux of the text data. The extraction system may provide the crux of the text data for display, may perform a search for a topic based on the crux of the text data, and/or the like. Thus, the extraction system may conserve computing resources, networking resources, and/or other resources that would have otherwise been consumed by failing to identify meaningful information and/or phrases in transcript data, failing to identify cruxes of conversations provided in transcript data, being unable to utilize the meaningful information and/or phrases and the cruxes of conversations, and/or the like.

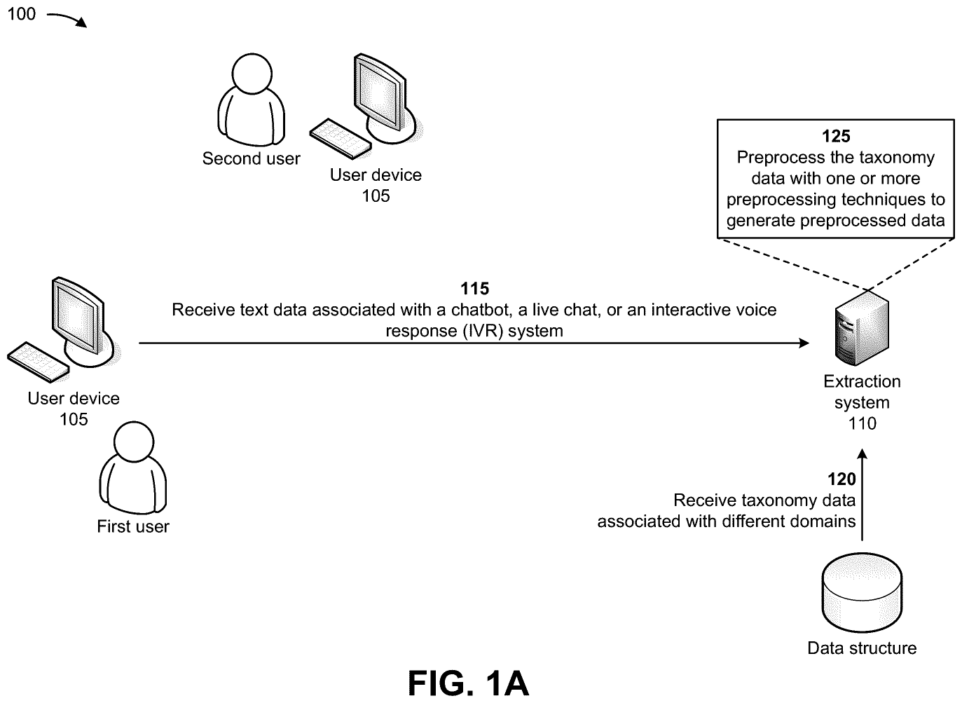

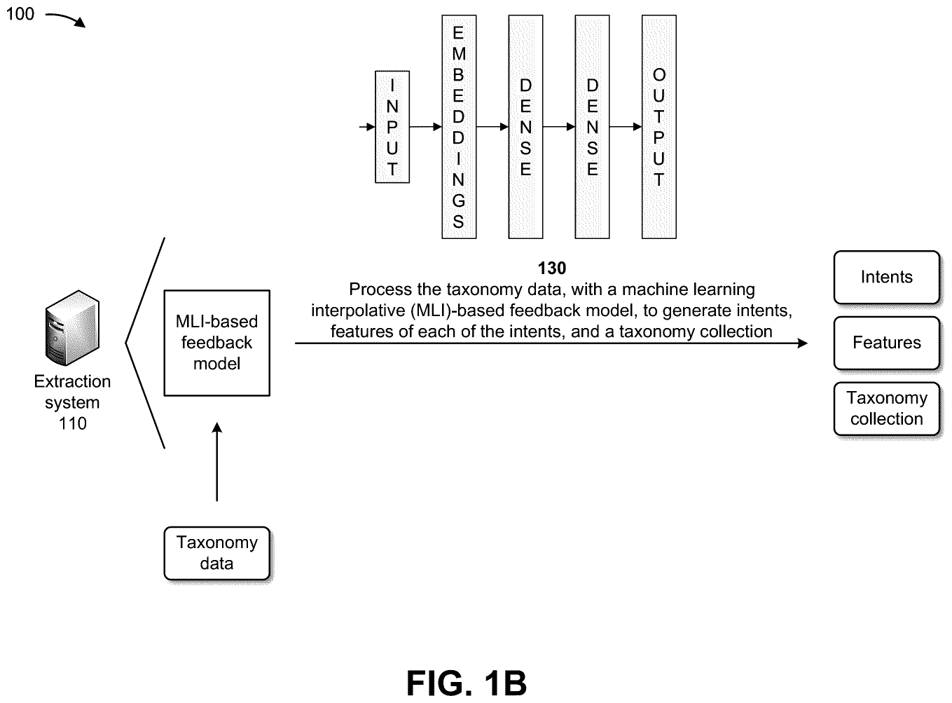

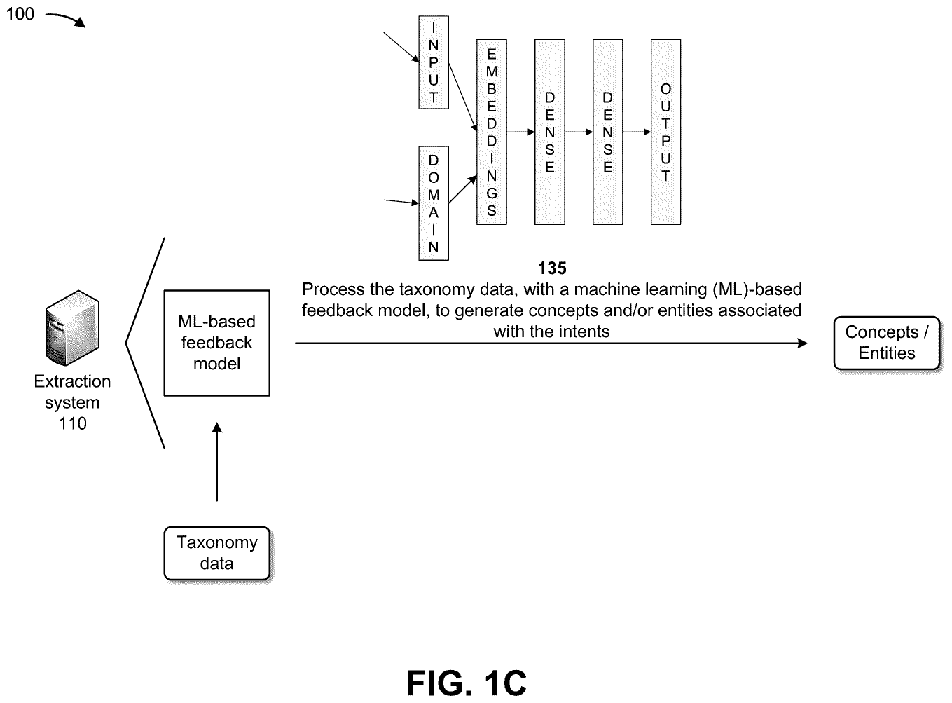

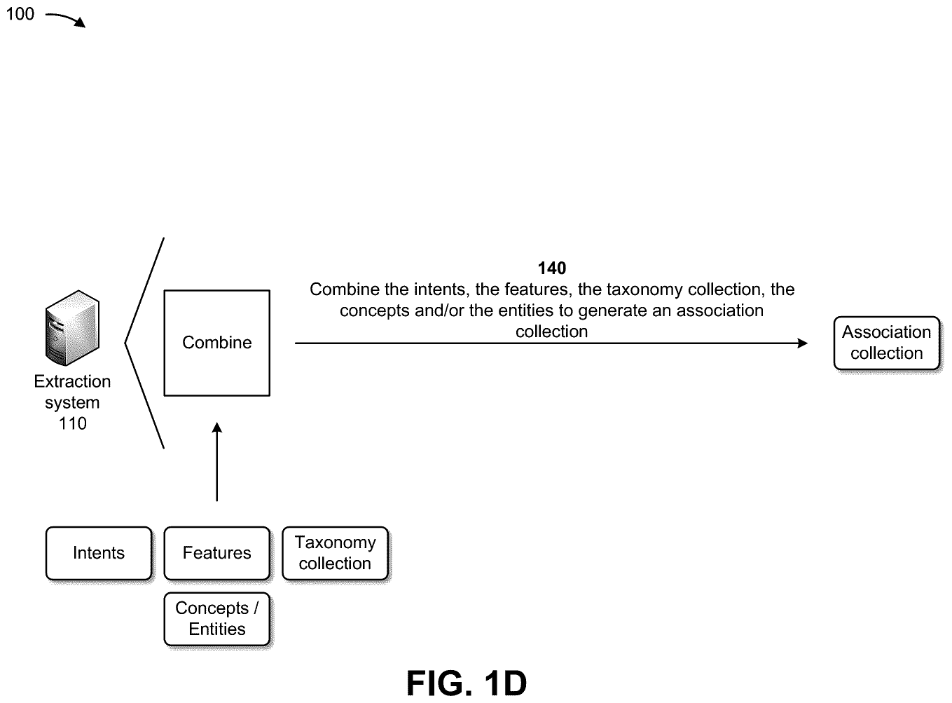

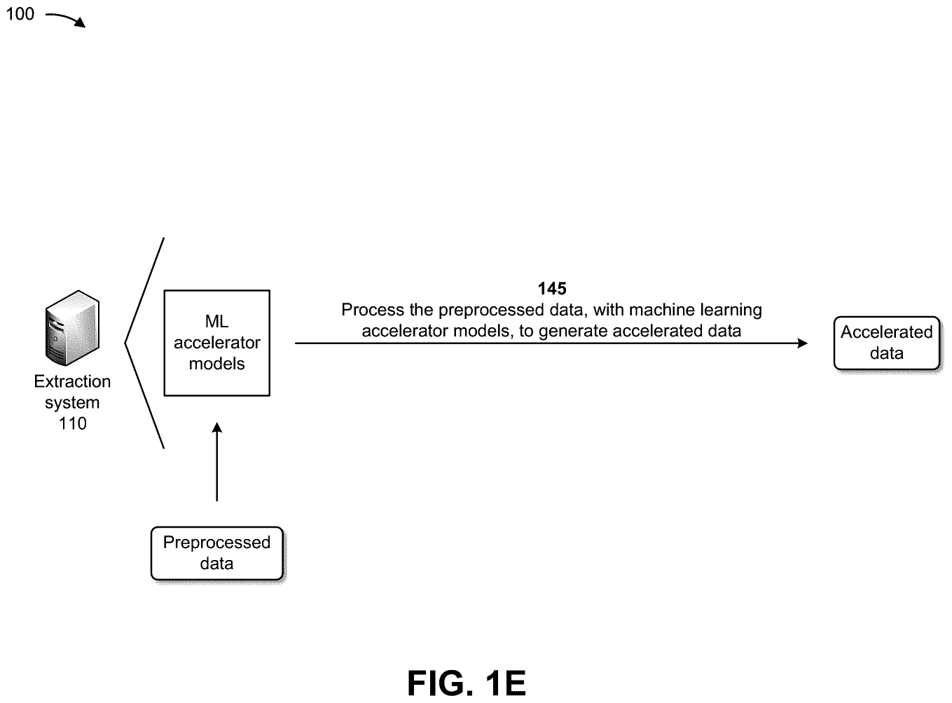

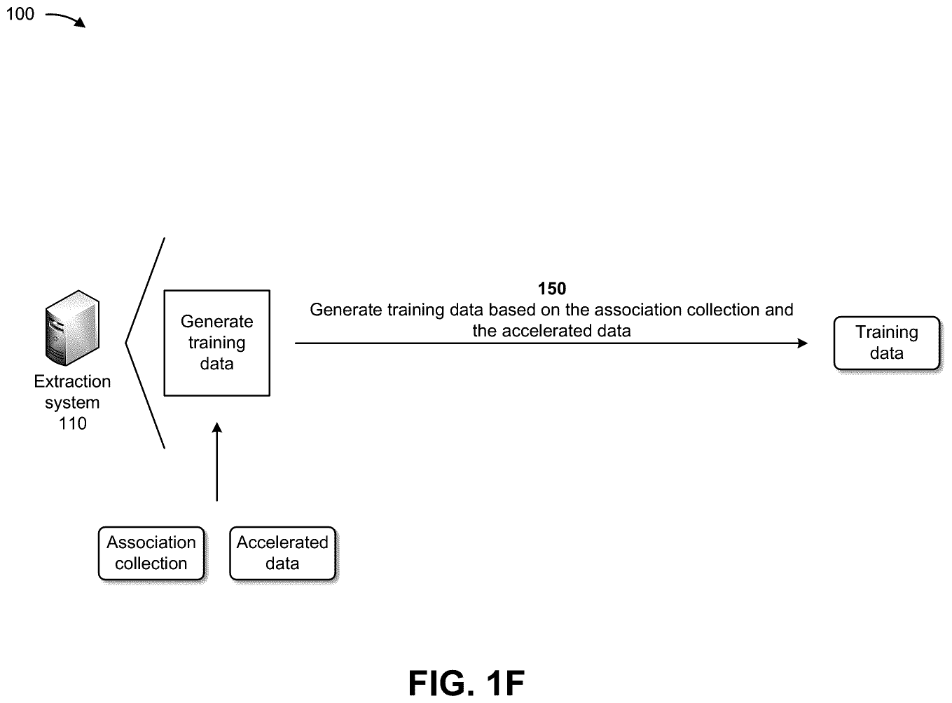

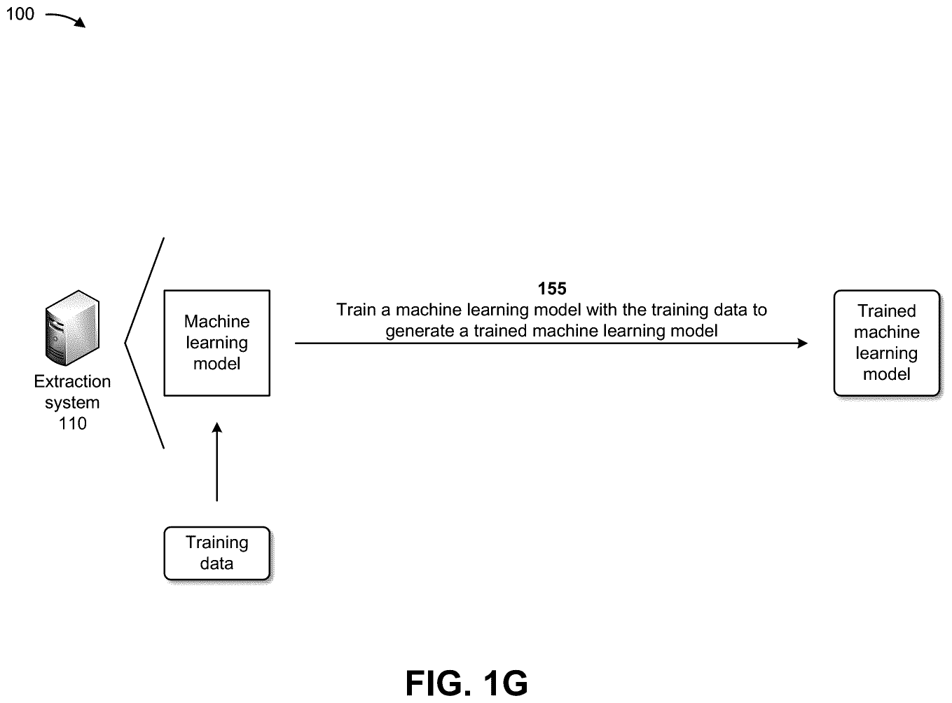

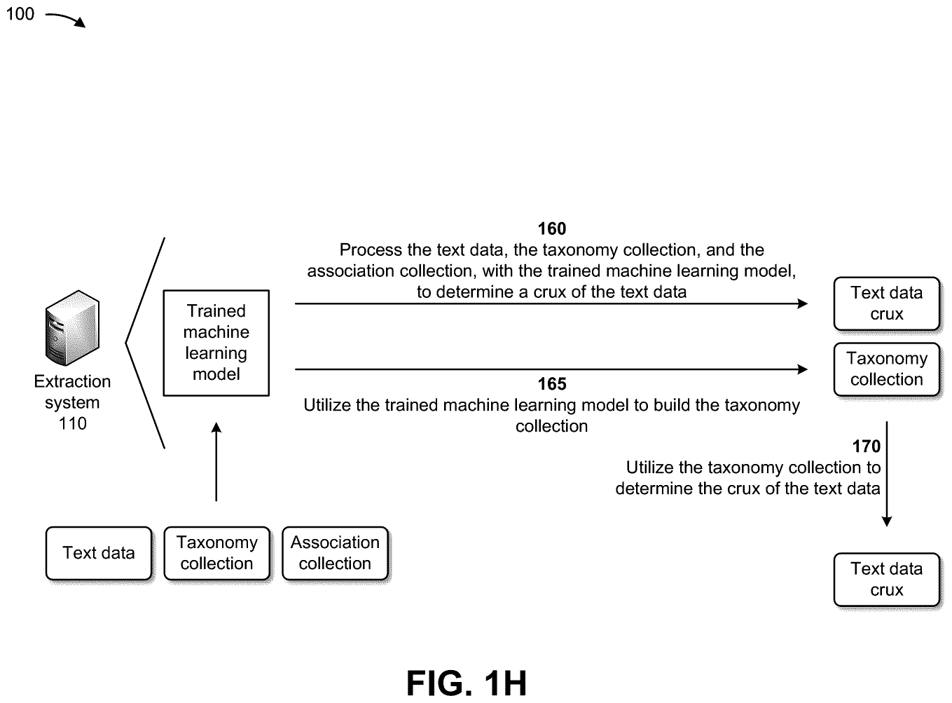

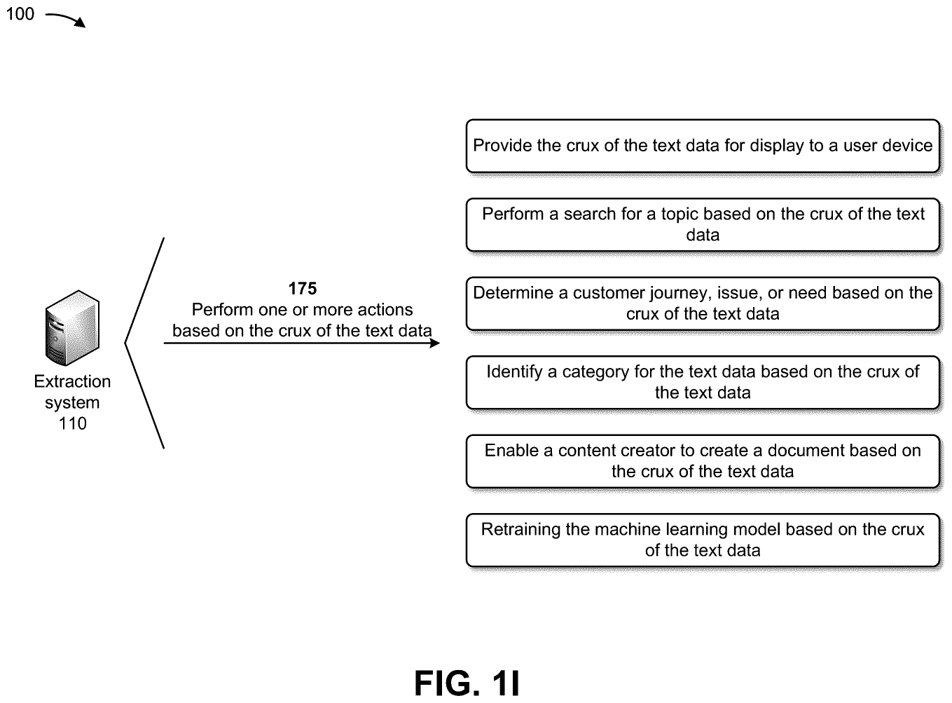

FIGS. 1A-1I are diagrams of an example 100 associated with extracting meaningful phrases and a crux of a conversation from text data. As shown in FIGS. 1A-1I, example 100 includes user devices 105 associated with users (e.g., a first user and a second user), a data structure (e.g., a database, a table, a list, and/or the like), and an extraction system 110. Further details of the user devices 105, the data structure, and the extraction system 110 are provided elsewhere herein.

As shown in FIG. 1A, and by reference number 115, the extraction system 110 may receive text data associated with a chatbot, a live chat, and/or an interactive voice response (IVR) system. For example, the first user device 105 and the second user device 105 (or another device, such as a server device, a cloud-based device, and/or the like) may provide a chatbot application, a live chat application, an IVR system application, a voice or video call application, and/or the like. The first user may utilize the applications to cause the first user device 105 to conduct voice or video calls, conduct live chats, provide interactive voice responses to the IVR system, provide inputs to chatbots, and/or the like. The first user device 105 and/or the second user device 105 may convert the voice or video calls from audio data to text data (e.g., call transcripts), may save the text data input via the live chats and the chatbots, may convert the interactive voice responses from audio data to text data, and/or the like. The first user device 105 and/or the second user device 105 may provide the text data to the extraction system 110, and the extraction system 110 may receive the text data. In some implementations, the extraction system 110 may continuously receive the text data in real time from the first user device 105 and/or the second user device 105, may periodically receive the text data from the first user device 105 and/or the second user device 105, may receive the text data from the first user device 105 and/or the second user device 105 based on requesting the text data, and/or the like.

As further shown in FIG. 1A, and by reference number 120, the extraction system 110 may receive taxonomy data associated with different domains. For example, the data structure may store volumes of unstructured and/or structured taxonomy data (e.g., call, chat, and/or IVR) requiring extraction of meaningful information and/or phrases that provide cruxes of whole conversations. The taxonomy data may include any type of text based or call transcript based conservations received via chatbots, live chats, calls, IVR, and/or the like. The taxonomy data may be associated with different domains. For example, the taxonomy data may be associated with different domains, such as domains associated with a telecommunication provider, a department store, a utility company call center, a government agency, and/or the like. The extraction system 110 may receive the taxonomy data associated with the different domains from the data structure. In some implementations, the extraction system 110 may continuously receive the taxonomy data from the data structure, may periodically receive the taxonomy data from the data structure, may receive the taxonomy data from the data structure based on requesting the taxonomy data, and/or the like.

As further shown in FIG. 1A, and by reference number 125, the extraction system 110 may preprocess the taxonomy data with one or more preprocessing techniques to generate preprocessed data. For example, the one or more preprocessing techniques may include a stop-word removal technique, a bad character removal technique, an abbreviation regular expression (regex) technique, a placeholder replace technique, a custom noun entity technique, a lemmatization technique, and/or the like. The extraction system 110 may perform the stop-word removal technique on the taxonomy data to generate the preprocessed data (e.g., by removing words that occur commonly in the taxonomy data, such as articles or pronouns). The extraction system 110 may perform the bad character removal technique on the taxonomy data to generate the preprocessed data (e.g., by removing unwanted characters from the taxonomy data). The extraction system 110 may perform the abbreviation regular expression technique on the taxonomy data to generate the preprocessed data (e.g., by generate regular expressions from abbreviations in the taxonomy data). The extraction system 110 may perform the placeholder replace technique on the taxonomy data to generate the preprocessed data (e.g., by replacing placeholders in the taxonomy data with actual information). The extraction system 110 may perform the custom noun entity technique on the taxonomy data to generate the preprocessed data (e.g., by identifying proper nouns in the taxonomy data). The extraction system 110 may perform the lemmatization technique on the taxonomy data to generate the preprocessed data (e.g., by grouping together different inflected forms of a same word).

As shown in FIG. 1B, and by reference number 130, the extraction system 110 may process the taxonomy data, with a machine learning interpolative (MLI)-based feedback model, to generate intents, features of each of the intents, and a taxonomy collection. For example, the extraction system 110 may be associated with a supervised machine learning model, such as the MLI-based feedback model. As shown, the MLI-based feedback model may include an input layer, an embeddings layer, one or more dense layers, and an output layer. The MLI-based feedback model may parse the taxonomy data (e.g., that includes terms, such as “delay,” “network issue,” “address change,” “card,” “dollars,” and/or the like) into parts of speech (POS) level data and phrase level data, and may provide the POS level data and the phrase level data to the input layer of the MLI-based feedback model. The MLI-based feedback model may generate embeddings for the taxonomy data (e.g., the POS level data and the phrase level data) with the embeddings layer of the MLI-based feedback model. The MLI-based feedback model may process the embeddings, with the one or more dense layers of the MLI-based feedback model, to generate the intents (e.g., “network,” “account,” or “payment”), the features of each of the intents (e.g., the top features, concepts, or words, such as “network issue,” “delay,” “address change,” and/or the like), and the taxonomy collection (e.g., a collection of the intents and the features of the intents). The MLI-based feedback model may output the intents, the features of each of the intents, and the taxonomy collection with the output layer of the MLI-based feedback model.

As shown in FIG. 1C, and by reference number 135, the extraction system 110 may process the taxonomy data, with a machine learning (ML)-based feedback model, to generate concepts and/or entities associated with the intents. For example, the extraction system 110 may be associated with an unsupervised machine learning model, such as the ML-based feedback model. As shown, the ML-based feedback model may include an input layer, a domain layer, an embeddings layer, one or more dense layers, and an output layer. The ML-based feedback model may parse the taxonomy data into POS level data (e.g., concepts and/or entities) and class data (e.g., classes for domains), may provide the POS level data to the input layer of the ML-based feedback model, and may provide the class data to the domain layer of the ML-based feedback model. The ML-based feedback model may generate embeddings for the taxonomy data (e.g., the POS level data and the class data) with the embeddings layer of the ML-based feedback model. The ML-based feedback model may process the embeddings, with the one or more dense layers of the ML-based feedback model, to generate the concepts and/or the entities associated with the intents (e.g., concepts and/or entities relevant to the classes of the class data). The ML-based feedback model may output the concepts and/or the entities with the output layer of the MLI-based feedback model.

As shown in FIG. 1D, and by reference number 140, the extraction system 110 may combine the intents, the features, the taxonomy collection, and the concepts and/or the entities to generate an association collection. For example, the extraction system 110 may associate the information output by the MLI-based feedback model and the ML-based feedback model by combining the intents, the features, the taxonomy collection, and the concepts and/or the entities to generate the association collection. In some implementations, the association collection may include meaningful verbs, adverbs, adjectives, secondary nouns, and/or the like of the intents, the features, the concepts, and/or the entities that are associated with the taxonomy collection.

As shown in FIG. 1E, and by reference number 145, the extraction system 110 may process the preprocessed data, with machine learning accelerator models, to generate accelerated data. For example, the extraction system 110 may be associated with machine learning accelerator models, such as a coreference resolution model, a semantic and dependency parsing model, and a summarization model. In some implementations, the extraction system 110 may process the preprocessed data, with the coreference resolution model, to generate a first portion of the accelerated data. The coreference resolution model may identify expressions that refer to the same entity in the preprocessed data. In some implementations, the extraction system 110 may process the preprocessed data, with the semantic and dependency parsing model, to generate a second portion of the accelerated data. The semantic and dependency parsing model may map each sentence of the preprocessed data into a formal representation of the sentence meaning in a form of a directed graph with arcs between pairs of words. In some implementations, the extraction system 110 may process the preprocessed data, with the summarization model, to generate a third portion of the accelerated data. The summarization model may computationally shorten the preprocessed data to create subset data that represents the most important or relevant information within the preprocessed data. In some implementations, the first portion of the accelerated data, the second portion of the accelerated data, and the third portion of the accelerated data may form the accelerated data.

As shown in FIG. 1F, and by reference number 150, the extraction system 110 may generate training data based on the association collection and the accelerated data. For example, when generating the training data based on the association collection and the accelerated data, the extraction system 110 may extract POS references from the association collection and the accelerated data, and may extract POS sequences from the association collection and the accelerated data. The extraction system 110 may perform an association check for the POS references and the POS sequences (e.g., to determine an association between the POS references and the POS sequences), and may generate the training data based on the POS references, the POS sequences, and performing the association check for the POS references and the POS sequences.

In some implementations, when generating the training data based on the association collection and the accelerated data, the extraction system 110 may generate relevant phrases and unmatched sentences based on the association collection and the accelerated data, and may utilize the relevant phrases as the training data. The extraction system 110 may process the unmatched sentences, with a named entity recognition and ontology model, to identify and classify named entities in the unmatched sentences. The extraction system 110 may process the unmatched sentences, with a POS sequence validation model, to validate POS sequences in the unmatched sentences and generate validated data. The extraction system 110 may update the association collection with the classified named entities and the validated data to generate an updated association collection. In some implementations, the extraction system 110 may generate the training data based on the updated association collection and the accelerated data.

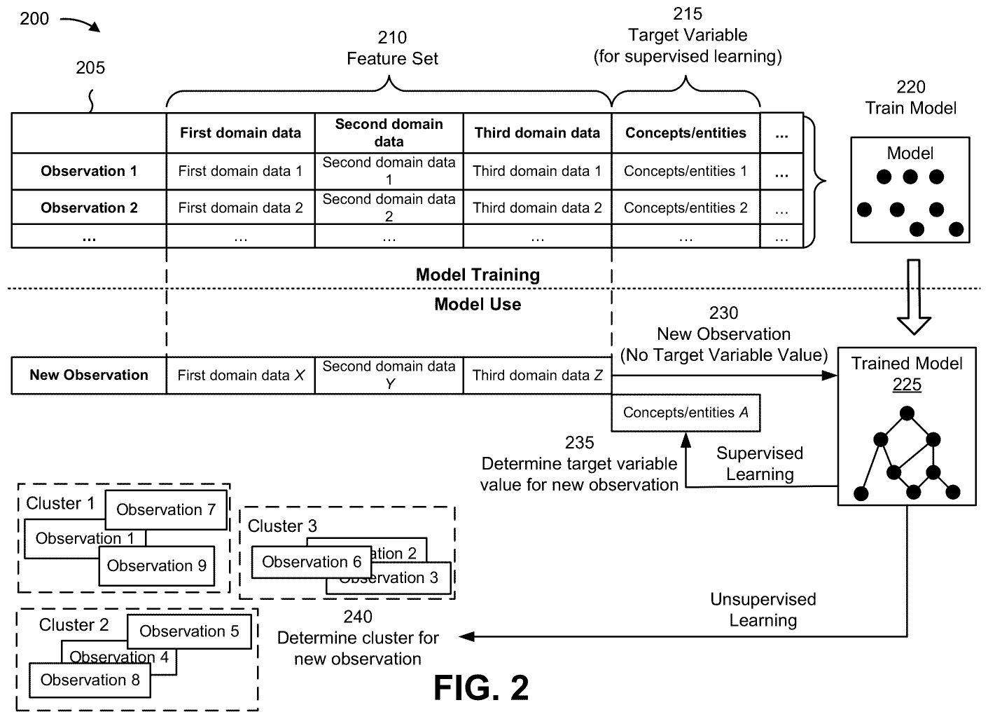

As shown in FIG. 1G, and by reference number 155, the extraction system 110 may train a machine learning model with the training data to generate a trained machine learning model. For example, the extraction system 110 may be associated with a machine learning model that combines text data, the taxonomy collection, and the association collection to determine a crux of the text data. In some implementations, the extraction system 110 may train the machine learning model, with the training data, to generate a trained machine learning model that combines text data, the taxonomy collection, and the association collection to determine a crux of the text data. In some implementations, when training the machine learning model with the training data to generate the trained machine learning model, the extractions system 110 may train the machine learning model to identify more relevant phrases in the training data relative to other phrases in the training data. Further details of training a machine learning model are provided below in connection with FIG. 2.

As shown in FIG. 1H, and by reference number 160, the extraction system 110 may process the text data, the taxonomy collection, and the association collection, with the trained machine learning model, to determine a crux of the text data. For example, the extraction system 110 may utilize the trained machine learning model to determine the crux of the text data based on the text data, the taxonomy collection, and the association collection. In some implementations, the crux of the text data may include an abstractive summarization of the text data. In some implementations, when processing the text data, the taxonomy collection, and the association collection, with the trained machine learning model, to determine the crux of the text data, the extraction system 110 may combine the text data, the taxonomy collection, and the association collection to determine the crux of the text data. In one example, the text data may include the language “Thank you. Its been great. No thanks, good night. How do I delete a phone on my account? Erik Doe has died and I want to take him off of our plan. ***.***.****. Yes, thanks. can you please take him off of our account and tell me what my next bill will be?. No thank you. yes. thank you. Its been hard. Thank you. Carrie Doe ***-***-****.” In such an example, the extraction system 110 may determine the crux of the text data as “how do i delete a phone on my account.”

As further shown in FIG. 1H, and by reference number 165, the extraction system 110 may utilize the trained machine learning model to build the taxonomy collection. For example, the extraction system 110 may process the text data, with the trained machine learning model, to build the taxonomy collection.

As further shown in FIG. 1H, and by reference number 170, the extraction system 110 may utilize the taxonomy collection to determine the crux of the text data (e.g., a conversation). For example, the extraction system 110 may process the taxonomy collection, built with the trained machine learning model, to determine the crux of the text data.

As shown in FIG. 1I, and by reference number 175, the extraction system 110 may perform one or more actions based on the crux of the text data. In some implementations, performing the one or more actions includes the extraction system 110 providing the crux of the text data for display to a user device. For example, the extraction system 110 may provide information identifying the crux of the text data to the first user device 105, and the first user device 105 may display the information identifying the crux of the text data to the first user. The first user may utilize the crux of the text data to assist the second user with the crux of the text data. In this way, the extraction system 110 conserves computing resources, networking resources, and/or other resources that would have otherwise been consumed by failing to identify meaningful information and/or phrases in transcript data.

In some implementations, performing the one or more actions includes the extraction system 110 performing a search for a topic based on the crux of the text data. For example, the extraction system 110 may utilize the crux of the text data to search for a topic associated with the crux, and may provide results of the search to the first user device 105. The first user device 105 may display the results of the search to the first user so that the first user may utilize the results to provide service to the second user. In this way, the extraction system 110 conserves computing resources, networking resources, and/or other resources that would have otherwise been consumed by failing to identify cruxes of conversations provided in transcript data.

In some implementations, performing the one or more actions includes the extraction system 110 determining a customer journey, issue, or need based on the crux of the text data. For example, if the second user is a customer and the first user is a customer service representative conversing with the second user, the extraction system 110 may determine the customer's journey, issue, or need based on the crux of the text data. The extraction system 110 may provide information identifying the customer's journey, issue, or need for display to the first user device 105 so that first user may quickly and appropriately address the customer's journey, issue, or need. In this way, the extraction system 110 conserves computing resources, networking resources, and/or other resources that would have otherwise been consumed by being unable to utilize the meaningful information and/or phrases and the cruxes of conversations.

In some implementations, performing the one or more actions includes the extraction system 110 identifying a category for the text data based on the crux of the text data. For example, the extraction system 110 may identify a category (e.g., network outage) for the text data based on the crux of the text data, and may utilize the category to search for information relevant to the category (e.g., a tree has disrupted network service in a particular area). The extraction system 110 may provide the information relevant to the category to the first user device 105 and the first user device 105 may display the information to the first user. In this way, the extraction system 110 conserves computing resources, networking resources, and/or other resources that would have otherwise been consumed by failing to identify meaningful information and/or phrases in transcript data.

In some implementations, performing the one or more actions includes the extraction system 110 enabling a content creator to create a document based on the crux of the text data. For example, the extraction system 110 may provide the crux of the text data to a content creator (e.g., a marketing manager), and the content creator may create a document (e.g., an advertisement, a video, and/or the like) based on the crux of the text data. The content creator may provide the document to the first user device 105, and the first user device 105 may display the document to the first user. In this way, the extraction system 110 conserves computing resources, networking resources, and/or other resources that would have otherwise been consumed by failing to identify cruxes of conversations provided in transcript data.

In some implementations, performing the one or more actions includes the extraction system 110 retraining the machine learning model based on the crux of the text data. For example, the extraction system 110 may utilize the crux of the text data as additional training data for retraining the machine learning model, thereby increasing the quantity of training data available for training the machine learning model. Accordingly, the extraction system 110 may conserve computing resources associated with identifying, obtaining, and/or generating historical data for training the machine learning model relative to other systems for identifying, obtaining, and/or generating historical data for training machine learning models.

In this way, the extraction system 110 extracts meaningful phrases and a crux of a conversation from text data. For example, the extraction system 110 may receive taxonomy data associated with different domains and may utilize a machine learning interpolative taxonomy feedback model to generate a taxonomy collection based on the taxonomy data. The extraction system 110 may utilize a machine learning taxonomy feedback model to generate an association collection based on the taxonomy data, and may train a machine learning model with the association collection and the taxonomy data. The extraction system 110 may receive text data associated with a chatbot, a live chat, an IVR, and/or the like, and may process the text data, the taxonomy collection, and the association collection, with the trained machine learning model, to determine a crux of the text data. The extraction system 110 may provide the crux of the text data for display, may perform a search for a topic based on the crux of the text data, and/or the like. Thus, the extraction system 110 may conserve computing resources, networking resources, and/or other resources that would have otherwise been consumed by failing to identify meaningful information and/or phrases in transcript data, failing to identify cruxes of conversations provided in transcript data, being unable to utilize the meaningful information and/or phrases and the cruxes of conversations, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

FIG. 2 is a diagram illustrating an example 200 of training and using a machine learning model to extract meaningful phrases and a crux of a conversation from text data. The machine learning model training and usage described herein may be performed using a machine learning system. The machine learning system may include or may be included in a computing device, a server, a cloud computing environment, and/or the like, such as the extraction system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the extraction system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the extraction system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of first domain data, a second feature of second domain data, a third feature of third domain data, and so on. As shown, for a first observation, the first feature may have a value of first domain data 1, the second feature may have a value of second domain data 1, the third feature may have a value of parts of third domain data 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be labeled “concepts/entities” and may include a value of concepts/entities 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of first domain data X, a second feature of second domain data Y, a third feature of third domain data Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of concepts/entities A for the target variable of the concepts/entities for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first domain data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second domain data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to extract meaningful phrases and a crux of a conversation from text data. The machine learning system enables recognition and/or identification of tens, hundreds, thousands, or millions of features and/or feature values for tens, hundreds, thousands, or millions of observations, thereby increasing accuracy and consistency and reducing delay associated with extracting meaningful phrases and a crux of a conversation from text data relative to requiring computing resources to be allocated for tens, hundreds, or thousands of operators to manually extract meaningful phrases and a crux of a conversation from text data.

As indicated above, FIG. 2 is provided as an example. Other examples may differ from what is described in connection with FIG. 2.

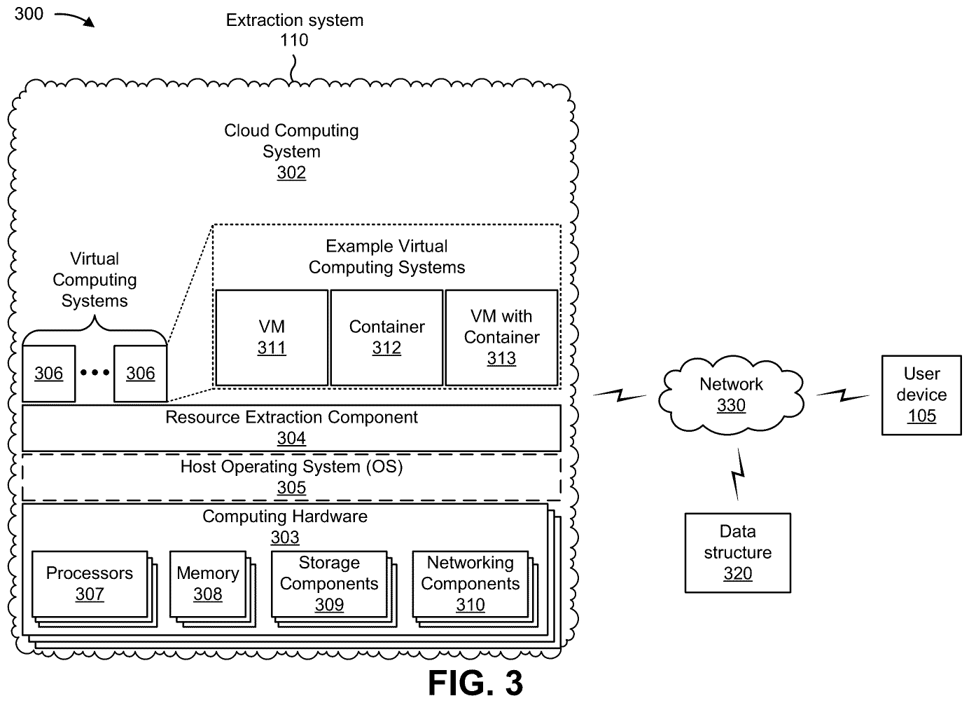

FIG. 3 is a diagram of an example environment 300 in which systems and/or methods described herein may be implemented. As shown in FIG. 3, the environment 300 may include the extraction system 110, which may include one or more elements of and/or may execute within a cloud computing system 302. The cloud computing system 302 may include one or more elements 303-313, as described in more detail below. As further shown in FIG. 3, the environment 300 may include the user device 105, a data structure 320, and/or a network 330. Devices and/or elements of the environment 300 may interconnect via wired connections and/or wireless connections.

The user device 105 includes one or more devices capable of receiving, generating, storing, processing, and/or providing information, such as information described herein. For example, the user device 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), an autonomous vehicle, or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

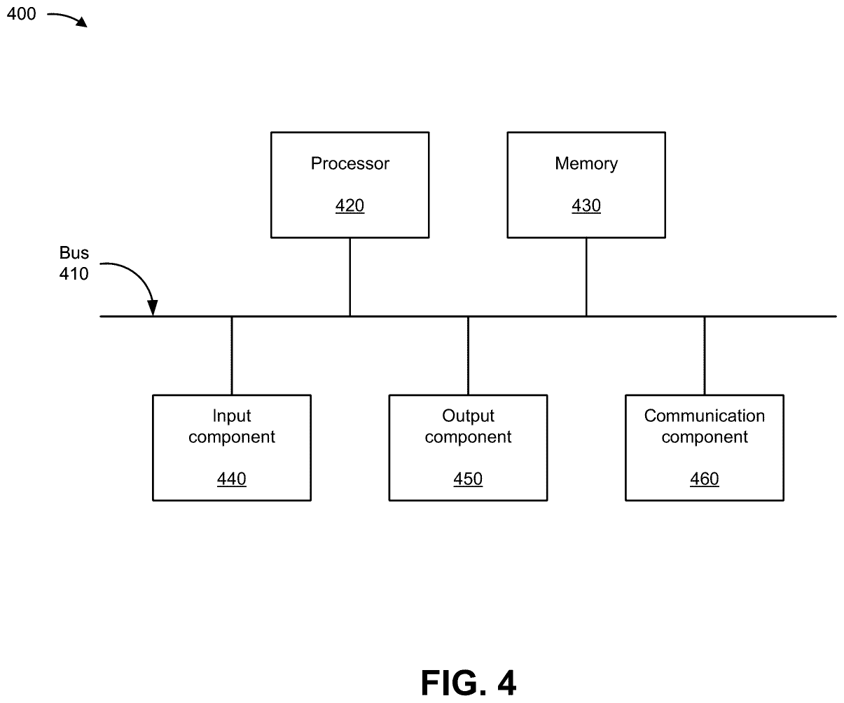

Although the extraction system 110 may include one or more elements 303-313 of the cloud computing system 302, may execute within the cloud computing system 302, and/or may be hosted within the cloud computing system 302, in some implementations, the extraction system 110 may not be cloud-based (e.g., may be implemented outside of a cloud computing system) or may be partially cloud-based. For example, the extraction system 110 may include one or more devices that are not part of the cloud computing system 302, such as the device 400 of FIG. 4, which may include a standalone server or another type of computing device. The extraction system 110 may perform one or more operations and/or processes described in more detail elsewhere herein.

The data structure 320 may include one or more devices capable of receiving, generating, storing, processing, and/or providing information, as described elsewhere herein. The data structure 320 may include a communication device and/or a computing device. For example, the data structure 320 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 320 may communicate with one or more other devices of the environment 300, as described elsewhere herein.

The network 330 includes one or more wired and/or wireless networks. For example, the network 330 may include a cellular network, a public land mobile network (PLMN), a local area network (LAN), a wide area network (WAN), a private network, the Internet, and/or a combination of these or other types of networks. The network 330 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105, the extraction system 110, and/or the data structure 320. In some implementations, the user device 105, the extraction system 110, and/or the data structure 320 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

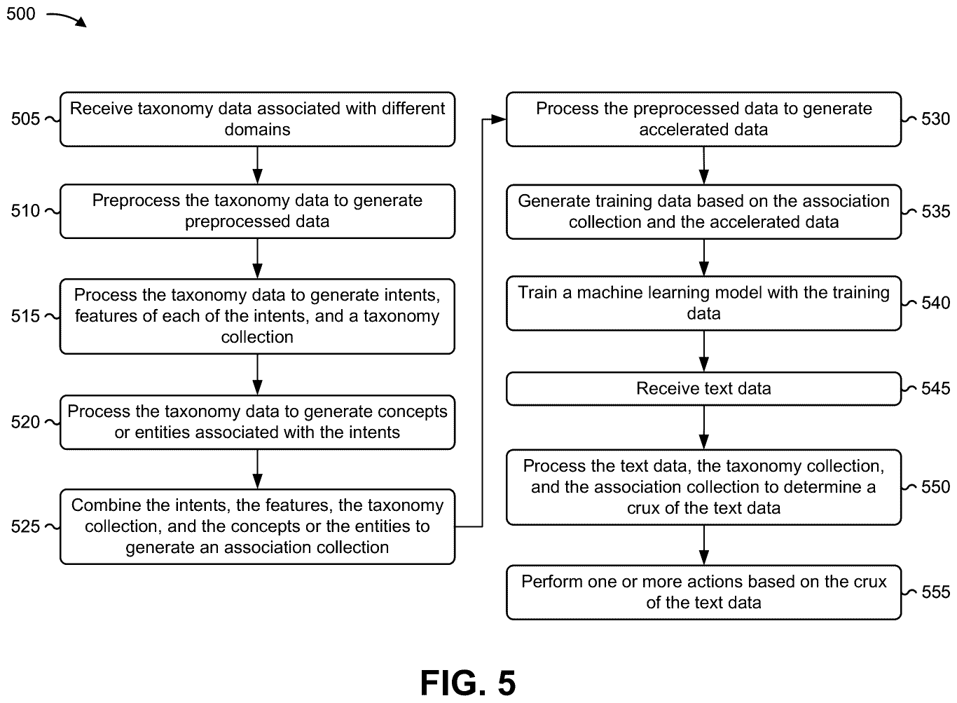

FIG. 5 is a flowchart of an example process 500 for extracting meaningful phrases and a crux of a conversation from text data. In some implementations, one or more process blocks of FIG. 5 may be performed by a device (e.g., the extraction system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving taxonomy data associated with different domains (block 505). For example, the device may receive taxonomy data associated with different domains, as described above.

As further shown in FIG. 5, process 500 may include preprocessing the taxonomy data to generate preprocessed data (block 510). For example, the device may preprocess the taxonomy data with one or more preprocessing techniques to generate preprocessed data, as described above. In some implementations, preprocessing the taxonomy data with one or more preprocessing techniques to generate the preprocessed data includes one or more of performing a stop-word removal technique on the taxonomy data to generate the preprocessed data; performing a bad character removal technique on the taxonomy data to generate the preprocessed data; performing an abbreviation regular expression technique on the taxonomy data to generate the preprocessed data; performing a placeholder replace technique on the taxonomy data to generate the preprocessed data; performing a custom noun entity technique on the taxonomy data to generate the preprocessed data; or performing a lemmatization technique on the taxonomy data to generate the preprocessed data.

As further shown in FIG. 5, process 500 may include processing the taxonomy data to generate intents, features of each of the intents, and a taxonomy collection (block 515). For example, the device may process the taxonomy data, with an MLI-based feedback model, to generate intents, features of each of the intents, and a taxonomy collection, as described above. In some implementations, processing the taxonomy data, with the MLI-based feedback model to generate the intents, the features of each of the intents, and the taxonomy collection includes receiving the taxonomy data with an input layer of the MLI-based feedback model, generating embeddings for the taxonomy data with an embeddings layer of the MLI-based feedback model, processing the embeddings, with one or more dense layers of the MLI-based feedback model, to generate the intents, the features of each of the intents, and the taxonomy collection, and outputting the intents, the features of each of the intents, and the taxonomy collection with an output layer of the MLI-based feedback model.

As further shown in FIG. 5, process 500 may include processing the taxonomy data to generate concepts or entities associated with the intents (block 520). For example, the device may process the taxonomy data, with an ML-based feedback model, to generate concepts or entities associated with the intents, as described above. In some implementations, processing the taxonomy data, with the ML-based feedback model, to generate the concepts or entities associated the intents includes receiving the taxonomy data with an input layer of the ML-based feedback model, receiving classes associated with the different domains with a domain layer of the ML-based feedback model, generating embeddings for the taxonomy data and the classes with an embeddings layer of the ML-based feedback model, processing the embeddings, with one or more dense layers of the ML-based feedback model, to generate the concepts or entities, and outputting the concepts or entities with an output layer of the ML-based feedback model.

As further shown in FIG. 5, process 500 may include combining the intents, the features, the taxonomy collection, and the concepts or the entities to generate an association collection (block 525). For example, the device may combine the intents, the features, the taxonomy collection, and the concepts or the entities to generate an association collection, as described above.

As further shown in FIG. 5, process 500 may include processing the preprocessed data to generate accelerated data (block 530). For example, the device may process the preprocessed data, with machine learning accelerator models, to generate accelerated data, as described above. In some implementations, processing the preprocessed data, with the machine learning accelerator models, to generate the accelerated data includes processing the preprocessed data, with a coreference resolution model, to generate a first portion of the accelerated data; processing the preprocessed data, with a semantic and dependency parsing model, to generate a second portion of the accelerated data; and processing the preprocessed data, with a summarization model, to generate a third portion of the accelerated data.

As further shown in FIG. 5, process 500 may include generating training data based on the association collection and the accelerated data (block 535). For example, the device may generate training data based on the association collection and the accelerated data, as described above. In some implementations, generating the training data based on the association collection and the accelerated data includes extracting POS references from the association collection and the accelerated data, extracting POS sequences from the association collection and the accelerated data, performing an association check for the POS references and the POS sequences, and generating the training data based on the POS references, the POS sequences, and performing the association check for the POS references and the POS sequences. In some implementations, generating the training data based on the association collection and the accelerated data includes generating relevant phrases and unmatched sentences based on the association collection and the accelerated data, and utilizing the relevant phrases as the training data.

As further shown in FIG. 5, process 500 may include training a machine learning model with the training data (block 540). For example, the device may train a machine learning model with the training data to generate a trained machine learning model, as described above. In some implementations, training the machine learning model with the training data to generate the trained machine learning model includes training the machine learning model to identify more relevant phrases in the training data relative to other phrases in the training data.

As further shown in FIG. 5, process 500 may include receiving text data (block 545). For example, the device may receive text data associated with a chatbot, a live chat, or an IVR system, as described above.

As further shown in FIG. 5, process 500 may include processing the text data, the taxonomy collection, and the association collection to determine a crux of the text data (block 550). For example, the device may process the text data, the taxonomy collection, and the association collection, with the trained machine learning model, to determine a crux of the text data, as described above. In some implementations, processing the text data, the taxonomy collection, and the association collection, with the trained machine learning model, to determine the crux of the text data includes combining the text data, the taxonomy collection, and the association collection to determine the crux of the text data. In some implementations, the crux of the text data is an abstractive summarization of the text data.

As further shown in FIG. 5, process 500 may include performing one or more actions based on the crux of the text data (block 555). For example, the device may perform one or more actions based on the crux of the text data, as described above. In some implementations, performing the one or more actions includes one or more of providing the crux of the text data for display to a user device; performing a search for a topic based on the crux of the text data; determining a customer journey, issue, or need based on the crux of the text data; identifying a category for the text data based on the crux of the text data; enabling a content creator to create a document based on the crux of the text data; or retraining the machine learning model based on the crux of the text data.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, taxonomy data associated with different domains;
preprocessing, by the device, the taxonomy data with one or more preprocessing techniques to generate preprocessed data;
processing, by the device, the taxonomy data, with a machine learning interpolative-based feedback model, to generate intents, features of each of the intents, and a taxonomy collection;
processing, by the device, the taxonomy data, with a machine learning-based feedback model, to generate concepts or entities associated with the intents;
combining, by the device, the intents, the features, the taxonomy collection, and the concepts or the entities to generate an association collection;
processing, by the device, the preprocessed data, with machine learning accelerator models, to generate accelerated data;
generating, by the device, training data based on the association collection and the accelerated data;
training, by the device, a machine learning model with the training data to generate a trained machine learning model;
receiving, by the device, text data associated with a chatbot, a live chat, or an interactive voice response system;
processing, by the device, the text data, the taxonomy collection, and the association collection, with the trained machine learning model, to determine a crux of the text data; and
performing, by the device, one or more actions based on the crux of the text data.

2. The method of claim 1, wherein preprocessing the taxonomy data with one or more preprocessing techniques to generate the preprocessed data comprises one or more of:
performing a stop-word removal technique on the taxonomy data to generate the preprocessed data;
performing a bad character removal technique on the taxonomy data to generate the preprocessed data;
performing an abbreviation regular expression technique on the taxonomy data to generate the preprocessed data;
performing a placeholder replace technique on the taxonomy data to generate the preprocessed data;
performing a custom noun entity technique on the taxonomy data to generate the preprocessed data; or
performing a lemmatization technique on the taxonomy data to generate the preprocessed data.

3. The method of claim 1, wherein processing the preprocessed data, with the machine learning accelerator models, to generate the accelerated data comprises:
processing the preprocessed data, with a coreference resolution model, to generate a first portion of the accelerated data;
processing the preprocessed data, with a semantic and dependency parsing model, to generate a second portion of the accelerated data; and
processing the preprocessed data, with a summarization model, to generate a third portion of the accelerated data.

4. The method of claim 1, wherein generating the training data based on the association collection and the accelerated data comprises:
extracting parts of speech (POS) references from the association collection and the accelerated data;
extracting POS sequences from the association collection and the accelerated data;
performing an association check for the POS references and the POS sequences; and
generating the training data based on the POS references, the POS sequences, and performing the association check for the POS references and the POS sequences.

5. The method of claim 1, wherein generating the training data based on the association collection and the accelerated data comprises:
generating relevant phrases and unmatched sentences based on the association collection and the accelerated data; and
utilizing the relevant phrases as the training data.

6. The method of claim 1, wherein training the machine learning model with the training data to generate the trained machine learning model comprises:
training the machine learning model to identify more relevant phrases in the training data relative to other phrases in the training data.

7. The method of claim 1, wherein processing the taxonomy data, with the machine learning interpolative-based feedback model to generate the intents, the features of each of the intents, and the taxonomy collection comprises:
receiving the taxonomy data with an input layer of the machine learning interpolative-based feedback model;
generating embeddings for the taxonomy data with an embeddings layer of the machine learning interpolative-based feedback model;
processing the embeddings, with one or more dense layers of the machine learning interpolative-based feedback model, to generate the intents, the features of each of the intents, and the taxonomy collection; and
outputting the intents, the features of each of the intents, and the taxonomy collection with an output layer of the machine learning interpolative-based feedback model.

8. A device, comprising:
one or more processors configured to:
receive taxonomy data associated with different domains;
preprocess the taxonomy data with one or more preprocessing techniques to generate preprocessed data;
process the taxonomy data, with a machine learning interpolative-based feedback model, to generate intents, features of each of the intents, and a taxonomy collection;
process the taxonomy data, with a machine learning-based feedback model, to generate concepts or entities associated the intents;
combine the intents, the features, the taxonomy collection, and the concepts or the entities to generate an association collection;
process the preprocessed data, with machine learning accelerator models, to generate accelerated data;
train a machine learning model with the association collection and the accelerated data to generate a trained machine learning model;
receive text data associated with a chatbot, a live chat, or an interactive voice response system;
process the text data, the taxonomy collection, and the association collection, with the trained machine learning model, to determine a crux of the text data; and
perform one or more actions based on the crux of the text data.

9. The device of claim 8, wherein the one or more processors, to process the taxonomy data, with the machine learning-based feedback model, to generate the concepts or entities associated the intents, are configured to:
receive the taxonomy data with an input layer of the machine learning-based feedback model;
receive classes associated with the different domains with a domain layer of the machine learning-based feedback model;
generate embeddings for the taxonomy data and the classes with an embeddings layer of the machine learning-based feedback model;
process the embeddings, with one or more dense layers of the machine learning-based feedback model, to generate the concepts or entities; and
output the concepts or entities with an output layer of the machine learning-based feedback model.

10. The device of claim 8, wherein the one or more processors, to process the text data, the taxonomy collection, and the association collection, with the trained machine learning model, to determine the crux of the text data, are configured to:
combine the text data, the taxonomy collection, and the association collection to determine the crux of the text data.

11. The device of claim 8, wherein the one or more processors, to perform the one or more actions, are configured to one or more of:
provide the crux of the text data for display to a user device; or
perform a search for a topic based on the crux of the text data.

12. The device of claim 8, wherein the one or more processors, to perform the one or more actions, are configured to one or more of:
determine a customer journey, issue, or need based on the crux of the text data; or
identify a category for the text data based on the crux of the text data.

13. The device of claim 8, wherein the one or more processors, to perform the one or more actions, are configured to one or more of:
enable a content creator to create a document based on the crux of the text data; or
retrain the machine learning model based on the crux of the text data.

14. The device of claim 8, wherein the crux of the text data is an abstractive summarization of the text data.

15. A non-transitory computer-readable medium storing a set of instructions, the set of instructions comprising:
one or more instructions that, when executed by one or more processors of a device, cause the device to:
receive taxonomy data associated with different domains;
preprocess the taxonomy data with one or more preprocessing techniques to generate preprocessed data;
process the taxonomy data, with a machine learning interpolative-based feedback model, to generate intents, features of each of the intents, and a taxonomy collection;
process the taxonomy data, with a machine learning-based feedback model, to generate concepts or entities associated the intents;
combine the intents, the features, the taxonomy collection, and the concepts or the entities to generate an association collection;
process the preprocessed data, with machine learning accelerator models, to generate accelerated data;
receive text data associated with a chatbot, a live chat, or an interactive voice response system;
combine the text data, the taxonomy collection, and the association collection to determine a crux of the text data; and
perform one or more actions based on the crux of the text data.

16. The non-transitory computer-readable medium of claim 15, wherein the one or more instructions, that cause the device to preprocess the taxonomy data with one or more preprocessing techniques to generate the preprocessed data, cause the device to one or more of:
perform a stop-word removal technique on the taxonomy data to generate the preprocessed data;
perform a bad character removal technique on the taxonomy data to generate the preprocessed data;
perform an abbreviation regular expression technique on the taxonomy data to generate the preprocessed data;
perform a placeholder replace technique on the taxonomy data to generate the preprocessed data;
perform a custom noun entity technique on the taxonomy data to generate the preprocessed data; or
perform a lemmatization technique on the taxonomy data to generate the preprocessed data.

17. The non-transitory computer-readable medium of claim 15, wherein the one or more instructions, that cause the device to process the preprocessed data, with the machine learning accelerator models, to generate the accelerated data, cause the device to:
process the preprocessed data, with a coreference resolution model, to generate a first portion of the accelerated data;
process the preprocessed data, with a semantic and dependency parsing model, to generate a second portion of the accelerated data; and
process the preprocessed data, with a summarization model, to generate a third portion of the accelerated data.

18. The non-transitory computer-readable medium of claim 15, wherein the one or more instructions, that cause the device to process the taxonomy data, with the machine learning interpolative-based feedback model to generate the intents, the features of each of the intents, and the taxonomy collection, cause the device to:
receive the taxonomy data with an input layer of the machine learning interpolative-based feedback model;
generate embeddings for the taxonomy data with an embeddings layer of the machine learning interpolative-based feedback model;
process the embeddings, with one or more dense layers of the machine learning interpolative-based feedback model, to generate the intents, the features of each of the intents, and the taxonomy collection; and
output the intents, the features of each of the intents, and the taxonomy collection with an output layer of the machine learning interpolative-based feedback model.

19. The non-transitory computer-readable medium of claim 15, wherein the one or more instructions, that cause the device to process the taxonomy data, with the machine learning-based feedback model, to generate the concepts or entities associated the intents, cause the device to:
receive the taxonomy data with an input layer of the machine learning-based feedback model;
receive classes associated with the different domains with a domain layer of the machine learning-based feedback model;
generate embeddings for the taxonomy data and the classes with an embeddings layer of the machine learning-based feedback model;
process the embeddings, with one or more dense layers of the machine learning-based feedback model, to generate the concepts or entities; and
output the concepts or entities with an output layer of the machine learning-based feedback model.

20. The non-transitory computer-readable medium of claim 15, wherein the one or more instructions, that cause the device to perform the one or more actions, cause the device to one or more of:
provide the crux of the text data for display to a user device;
perform a search for a topic based on the crux of the text data;
determine a customer journey, issue, or need based on the crux of the text data;
identify a category for the text data based on the crux of the text data;
enable a content creator to create a document based on the crux of the text data; or
retrain the machine learning model based on the crux of the text data.
